(19) United States
(12) Patent Application Publication
(10) Pub. No.: US 2003/0044746 A1
(43) Pub. Date: Mar. 6, 2003

(54) User removable fasteners

(76) Inventors: Leonard Marotta, West Islip, NY (US); John Mizzi, Poughkeepsie, NY (US)

Correspondence Address: ALFRED M. WALKER, 225 OLD COUNTRY ROAD, MELVILLE, NY, 11747-2712, US

(21) Appl. No.: 10/056,100

(22) Filed: Jan. 24, 2002

Related U.S. Application Data
(60) Provisional application No. 60/316,832, filed on Aug. 31, 2001.

(51) Int. Cl. A61C 3/00

(52) U.S. Cl. 433/18; 433/8; 433/173

(57) ABSTRACT

A removable orthodontic implant brackets for straightening teeth, wherein the implant is implanted into the palate roof of the mouth, includes a patient removable palate anchor connector as well as patient removable tooth connectors which attach the ends of palatal wires to tabs which are adhesively bonded to a tooth. Due to the geometries of the connectors, the connectors have low insertion and removal forces, positive locking of connected sections, and resist rotation in all planes. During removal, a captive actuator stud is simply pulled up or pressed down to deploy or retract the dual locking studs which operate in a plane orthogonal to the direction of movement.

### FIELD OF THE INVENTION

The present invention relates to user removable fasteners, such as patient removable orthodontic implant brackets for straightening teeth, wherein the implant is implanted into the palate roof of the mouth. The user removable fastener is also applicable for jewelry clasps and clothing fasteners.

### BACKGROUND OF THE INVENTION

Orthodontic appliances utilizing a palate anchor attached to an implant are in use. The palate anchor is rigidly inserted in the palate roof of a mouth. Palatal wires rigidly attached to this anchor terminate at their distal end in an orthodontic tab which is adhesively attached to the surface of a tooth.

In other applications, a palatal plate conforming to and covering a substantial area of the palate is used instead of the palatal wires. Unlike user removable teeth dentures, these appliances rely upon the high rigidity of their attachments. They must resist twisting and pull-off forces generated by reactions to the beneficial restoring forces they apply. In addition, they must resist the normal rigors encountered while eating and chewing.

Obviously, such appliances present a challenge to good dental hygiene when they are permanently attached for an extended period.

This invention creates the opportunity for patient removal of the orthodontic appliance for cleaning; it is then reattached to the palate anchor and distal attachments. No tools are required. These removable attachments approach the rigidity of the permanent attachment techniques which use screws and/or adhesive bonding.

Some prior art connectors have used ball and socket joints which are spring or elastomer actuated. These do not resist rotation and have pull-out forces which are comparable to the insertion forces. A minimum of three such joints are required to resist rotation in three mutually orthogonal directions.

Many other types of connectors such as pins and dovetails are available to the dental industry, however it is difficult to adapt these to solve the problem at hand in an efficient and usable compact configuration.

Among related prior art patents include U.S. Pat. No. 4,447,209 of Sutter which discloses a non-rotational jaw implant consisting of a plurality of grooved cylinders attached circumferentially to the implant.

U.S. Pat. No. 5,030,094 of Nardi discloses a non-movable palate anchor rigidly attached to orthodontic connectors connecting the palate anchor to the teeth being straightened.

U.S. Pat. No. 5,092,771 of Tatum discloses a hexagonal attachment of an implant rod to an implant socket.

U.S. Pat. No. 5,108,288 of Perry discloses a non-rotational jaw implant having a polygonal socket engagable with a polygonal abutment.

U.S. Pat. No. 5,221,206 of Nardi discloses an anti-rotational fixture for a dental prosthesis consisting of a pair of ball and socket joints joined laterally by a longitudinally extending support bar, to prevent rotation of the respective balls within the respective sockets.

U.S. Pat. No. 5,413,480 of Musikant discloses a denture attachment member including a ball and socket joint, wherein the spherical ball has two or more protrusions extending through the socket wall to resist rotation of the ball within the socket.

U.S. Pat. No. 5,433,607 of Schmid discloses a jaw implant having a plurality of anti-rotational spikes anchoring the implant into a jaw bone.

U.S. Pat. No. 5,456,723 of Steinemann discloses an implantable metallic tooth implant.

U.S. Pat. No. 5,769,630 of Hoffman discloses a non-movable palate anchored orthodontic bracket.

U.S. Pat. Nos. 6,312,259 of Kvarnstorm, 5,836,768 of Huskens and 5,697,779 of Sachdeva all disclose anchoring an implant to a adjacent teeth by spanning wires. Kvarnstorm '259 also describes a fixed palate anchor.

However, the prior art orthodontic connectors are generally configured to resist removal, other than by a dentist using specialized untightening tools.

### OBJECTS OF THE INVENTION

It is therefore an object of the present invention to provide a user removable fastener in dentistry, jewelry and clothing.

It is also an object of the present invention to provide a movement resistant orthodontic palate implant bracket which can be easily removed by an orthodontic patient for cleaning and reinsertion within the mouth of the patient.

Other objects which become apparent from the following description of the present invention.

### SUMMARY OF THE INVENTION

In keeping with these objects and others which may become apparent, in contrast to the prior art, this invention describes a user removable fastener, such as a palate anchor connector which attaches the ends of spanning palatal

wires to orthodontic tabs which are attached to a tooth, such as by adhesive bonding or other suitable attachments.

Also, in contrast to the prior art, the present invention, by using geometries which separate parameters, creates connectors which have low insertion and removal forces, positive locking of connected sections, and which resist rotation in all planes.

The user removable fastener includes a detachable palate bracket connector having a movable actuator member therein, wherein said detachable palate bracket connector is in nested engagement with a fixed stationary connector attached to the palate anchor. A similar connector is present at the tooth end of the spanning wire or member connecting the palate bracket to a tooth being straightened.

In a preferred embodiment, the spanning palate anchor connector is a low profile design which uses dual locking studs to rigidly lock a shell which fits over a custom designed abutment; the latter is screwed or otherwise attached rigidly to an implant. For example, the dual locking studs may rigidly lock a hexagonal or other geometrically shaped shell to fit over a similarly shaped hexagonal or other geometrically shaped abutment attached to an implant.

The palatal wires or palate plate are bonded to the removable shell while the abutment stays attached to the palate anchor upon removal. A captive actuator stud is simply pulled up or pressed down to deploy or retract the lock, such as a pair of dual locking studs, which operate in a plane orthogonal to the direction of movement. This results in a “dead bolt” type of connection with rotation resistance and alignment for the locking studs provided by the nested geometry, such as, for example, hex-on-hex nesting.

It can be appreciated that non-hexagonal contours can be used as well as long as they provide nesting and anti-rotation features. Some examples are a round contour with a flat region, square, or octagonal shapes.

The tooth connectors at the opposite end of the spanning palatal wires or palate plate use a small lock, such as a protrusion on a tab which is bonded to a tooth. For example, the protrusion may be a small cubic protrusion. A conformable socket member with a cavity, such as cubic end cavity is attached to the end of a palatal wire. A hole which is in positional registration in both the protrusion and the socket is then used to prevent pull-out of the two mated parts by inserting a captive locking stud through the hole. Pulling up on the stud releases the two parts. The square protrusion in the square cavity resists rotation while the locking stud prevents pull-out. Non-square rectangular as well as other shapes can also be used.

The method of removal simply involves unlocking the palate anchor connector followed by unlocking the tooth connectors. Then the palate connector shell is lifted off the abutment and the appliance is moved back slightly to disconnect the tooth connectors; the appliance is then free. Reinsertion is just the reverse process ending with locking of the palate anchor connector.

The preferred embodiment has uses hollow shells or sockets detachable from fixed abutments therein, to provide a cap over the connectors to minimize food bacteria lodging on the connectors. However, other configurations are possible, such as an upwardly open fixed abutment shell having a detachable rod with a movable actuator therein.

In the jewelry clasp and clothing fastener applications, similar devices can be used for easy locking and unlocking of tiny jewelry pieces, as well as for quickly fastening and unfastening of clothes.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a perspective top view of an upper maxillary jaw palate with an anchored orthodontic appliance using the connectors of this invention;

FIG. 2 is a perspective exploded view of the palate anchor connector thereof;

FIG. 3 is a side crossectional view of shell of the palate connector taken along line 3-3 of FIG. 2, showing the relation of an actuator stud;

FIG. 4 is a bottom view of a shell of the palate connector, showing the formation of the retention bar by selective material removal;

FIG. 5 is a perspective view of an elastomeric sleeve insert with locking studs;

FIG. 6 is a side crossectional view of the palate anchor connector in a locked position;

FIG. 7 is a side crossectional view of the palate anchor connector in an unlocked position;

FIG. 8 is a perspective view of an alternate embodiment of an insert with integral locking studs;

FIG. 9 is a perspective exploded view of another embodiment for a tooth connector used with the palate connectors shown in FIGS. 2-8;

FIG. 10 is a side elevational view of a locking stud for the tooth connector as in FIG. 9;

FIG. 11 is a side elevational view of the locked tooth connector as in FIG. 9;

FIG. 12 is a top plan view of another alternate embodiment for an abutment with an insert of a preferred embodiment of a palate anchor connector;

FIG. 13 is a side view of an actuator stud of the preferred embodiment of FIG. 12;

FIG. 14 is a bottom view of the shell of the preferred embodiment of FIG. 12;

FIG. 15 is a top plan view of yet another embodiment for a alternate spring metal insert for the preferred embodiment;

FIG. 16 is a side elevation view of an alternate embodiment of actuator stud with a mechanical captivating feature;

FIG. 17 is a bottom plan view of a palate connector shell with captive actuator stud of the alternate embodiment;

FIG. 18 is a top plan view of a contour of an alternate embodiment for a palate anchor connector in the shape of a circle with a flat facet;

FIG. 19 is a top plan view of a contour of another alternate embodiment for a palate anchor connector in the shape of a square;

FIG. 20 is a top plan view of a contour of a further alternate embodiment for a palate anchor connector in the shape of an octagon;

FIG. 21 is a side elevational view of an alternate embodiment for a jewelry fastener; and,

FIG. 22 is a side elevational view of an alternate embodiment for a clothing fastener.

### DETAILED DESCRIPTION OF THE INVENTION

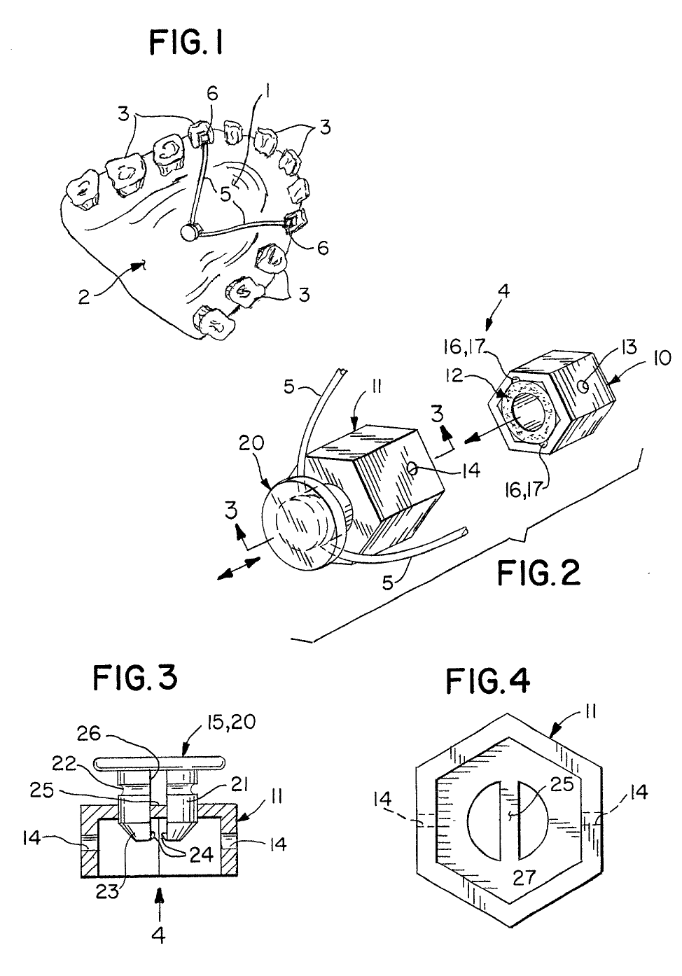

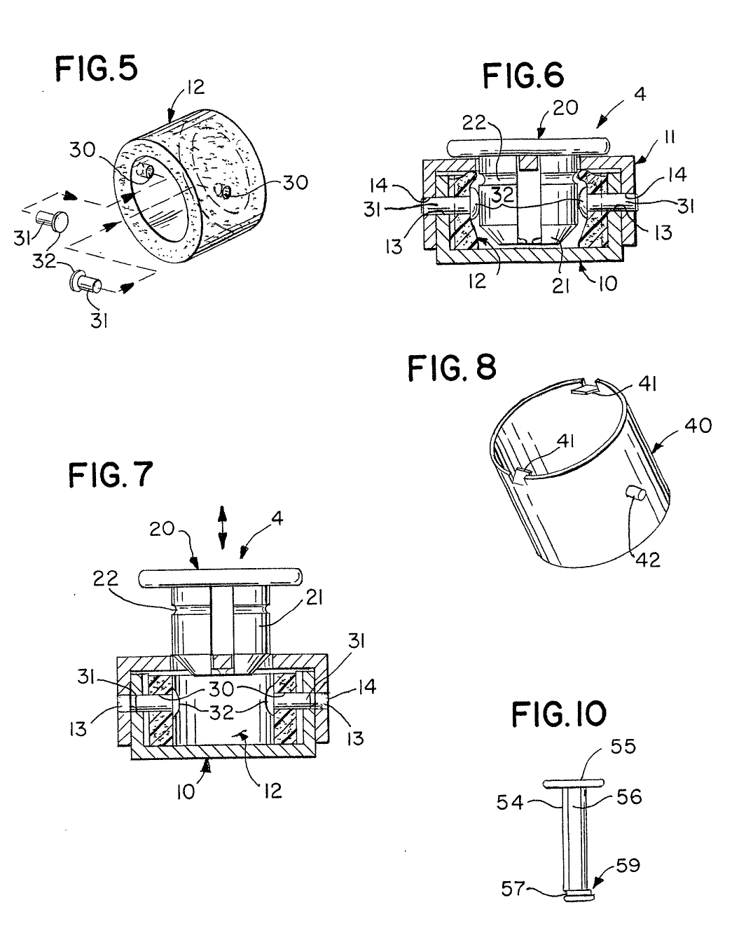

FIGS. 1-20 herein describes various patient removable orthodontic palate brackets for removing palate brackets for the mouth for hygienic cleaning thereof.

For example, FIG. 1 shows an upper maxillary jaw with an anchored orthodontic appliance 1 attached to palate 2 by palate anchor connector 4 of this invention, to which are attached palatal wires 5. Distal ends of wires 5 are attached through tooth connectors 6 of this invention to teeth 3. While FIG. 1 shows an upper maxillary jaw, the present invention can also be used with a lower mandibular jaw, where clearance is provided for movement of the tongue during chewing and speech.

FIG. 2 shows an exploded view of the two parts that make up the palate anchor connector of this invention. This includes abutment 10 which is rigidly attached to an implant by well known methods such as an anti-rotation fixture and screw. While other geometric configurations are applicable, FIG. 2 shows abutment 10 having a hexagonal outer contour that fits into (in a nesting relationship) to a recess (not shown) in hexagonal shell 11, to which palatal wires 5 are bonded (as by welding or soldering). The cap 20 of a connector actuator is shown as well as lock stud hole 14. Abutment 10 has lock stud holes 13 and a major circular recess 16 with extensions 17. An elastomeric insert 12 is shown within recess 16.

FIG. 3 is a side elevational view with shell 11 in crossection and actuator stud 15 with end chamfer 23, slot 26, and retention groove 22. Bar 25 permits actuator 15 to slide up and down by virtue of slot 26. Actuator 15 is prevented from getting dislodged (when pulled up) by end constraint 24 which bridges slot 26 thereby captivating actuator 21. Constraint 24 can be welded shut or brazed or soldered (if metallic), or an adhesive paste can be used to bridge the gap after stud 15 is inserted over bar 25.

The underside view of shell 11 in FIG. 4 shows how bar 25 is formed by selectively removing circular sector areas 27 from the top surface as by using a punch or by electrical discharge machining (EDM).

Insert 12 is shown in FIG. 5. Locking studs 31 with heads 32 are inserted through holes 30 from the interior surface of insert 12, which is a short length of a circular crossection elastomeric tube. Optional adhesive bonding of studs 31 to insert 12 is recommended but not required. By pressing insert 12 so that stud heads 32 are touching, it can be inserted into recess 16 by alignment with extensions 17 such that the straight ends of studs 31 will then enter holes 13 when compression is released. This action retains insert 12 within circular recess 16. To further insure retention of insert 12 within recess 16 and to deny the regions of extensions 17 to contamination, an elastomeric caulk can be used to fill these regions.

FIG. 6 is a side crossectional view of palate anchor connector 4 in the locked configuration with actuator 15 pressed down. The sides 21 of actuator stud 15 push locking studs 31 outward by compressing sleeve 12 thereby engaging holes 14 of shell 11. At the same time, the upper edge of sleeve 12 rolls over into retention groove 22 to offer some additional pull-out resistance to actuator stud 21 besides the friction offered by the compressed sleeve 12.

FIG. 7 shows the same scene, but with actuator stud 15 pulled up to its top most position against constraint 24. FIG. 7 shows that elastomeric insert 12 has now returned to it uncompressed configuration, thereby pulling locking studs 31 inward releasing shell 11, so that it can now just be lifted off abutment 10.

FIG. 8 shows an alternate embodiment of insert 40 which is a substitute for elastomeric insert 12. This is a length of oval spring tubing such as stainless steel. Tabs 41 are formed at the major diameter at opposite ends of the top edge. Locking studs 42 are welded or otherwise attached to the opposite sides as shown. By pressing sides of insert 40 and aligning it with extensions 17, it can be popped into recess 16 of abutment 10 in much the same manner as described for insert 12. Locking studs 42 are normally biased to retain insert 40 within recess 16 by studs 42, but they will not extend to engage shell 11 by extending into holes 14 until actuator stud 15 is pushed down, thereby reforming oval insert 40 into a circular shape. This action also brings tabs 41 into engagement with retention groove 22, thereby contributing to a greater pull-out resistance for actuator 15. The operation is the same as for the use of elastomeric insert 12.

FIG. 9 shows an exploded view of tooth connector 6 attached to tooth 3. One part includes an adhesively bonded tab 50 with a protrusion 51, such as a cubic protrusion, having a through hole 53 inside relief recess 52. The other part is a hollow member or housing 58 such as a hollow cubic member, attached to the distal end of palatal wire 5. The opening in the end of housing 58 is sized to receive cubic protrusion 51 in a reasonably tight fit. Captive locking stud 54 with cap 55 and flat side 56 slides through member 58 through holes in the top and bottom surface. A small plate 57 attached to member 58 makes locking stud 54 captive so as not to pose a choking or airway hazard.

In FIG. 10, step 59 at the distal end of stud 54 can be seen; this interacts with plate 57 to comprise the captive aspect. Thus plate 57 is attached (as by welding, soldering, or adhesive bonding) to housing member 58 after stud 56 is inserted through the top hole.

FIG. 11 shows a side view of the attached and locked connector 6. When stud 54 is fully engaged as shown, bottom retention groove interacts with leaf spring 60 (attached to housing 58) to click in place giving the user a tactile and sound cue as to the successful latching of connector 6. Recess 52 in the top surface of protrusion 51 aids in the easy removal of housing 58 when locking stud 54 is raised to its highest position since it may protrude slightly below the inside surface of housing 58.

FIGS. 2-8 describe an embodiment for a palate connector 4 using two locking studs 31 to lock together shell 11 to abutment 10. While this provides adequate pull-out resistance and rigidity, if the tolerances relating the side walls, height dimensions and hole locations of shell 11 and abutment 10 are not exact, there is the possibility of slight rocking movement using diametrically opposite locking studs 31 (or 42) as pivots.

Therefore, to deny the pivoting possibility while increasing rigidity of the overall connection in the same space, a preferred embodiment using three locking studs is described in FIGS. 12-15.

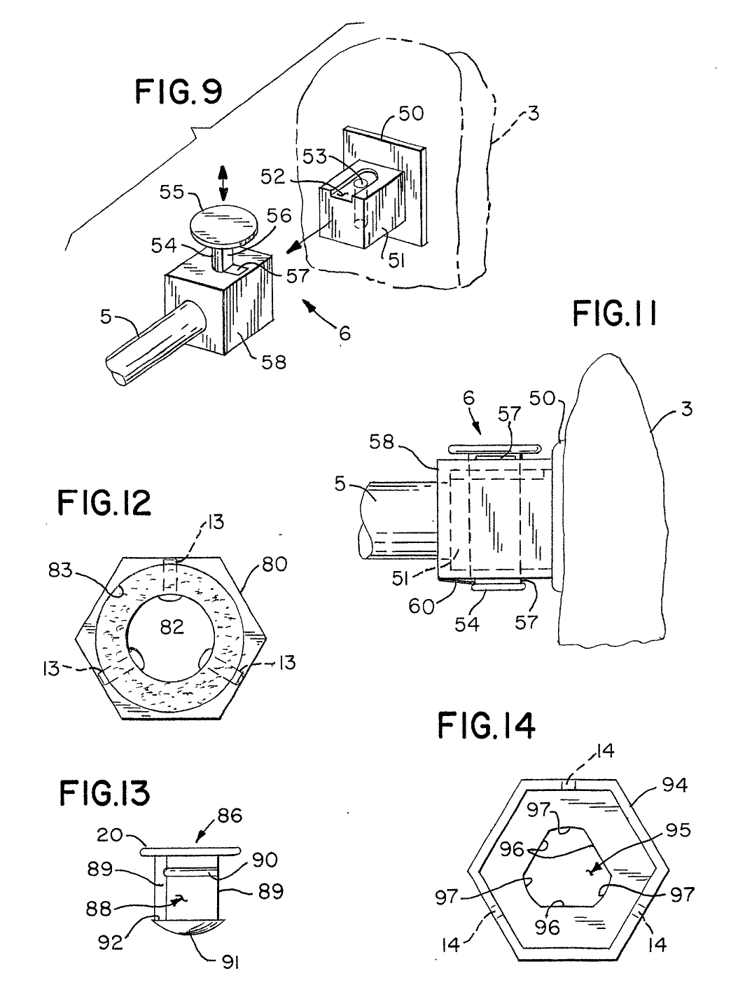

For example, FIG. 12 shows abutment 80 with three side holes 13 spaced 120 degrees apart. Recess 83 is circular and does not require relief areas (such as recess extension 17 in FIG. 2) since locking studs 82 no longer interfere with each other during the deformation of elastomeric ring 81 during insertion in recess 83. Actuator stud 86 with retention groove 90 and round shaft 88 has three flat areas 89 spaced 120 degrees apart which engage flat areas 96 (see FIG. 14) in the top surface of shell 94. Cut out 95 in the center of shell 94 is punched out or formed by electrical discharge machining (EDM), to receive the shaft 88 of actuator stud 86. Contours 97 guide the circular regions. By sliding shaft 88 into cut out 95 and then attaching spherical segment 91 in a concentric manner to the distal end of shaft 88, three steps 92 will engage three flats 96 to prevent disengagement of actuator stud 86 from shell 94.

In addition, shell 94 has three holes 14 in positional registration with three holes 13 of abutment 80 when these two parts are assembled.

FIG. 15 shows the top contour 101 of a short length of a tubular spring illustrating an alternative to elastomeric ring 81. Subassembly 100 has three welded or otherwise attached locking studs 102 spaced 120 degrees apart. Tabs 103 at the top edge engage retention groove segments 90 in actuator stud 86 when it is fully down in the locking position.

A variety of materials compatible with dental appliance manufacture can be used to fabricate palate anchor connector 4 and tooth connectors 6. For example, rigid parts can be fabricated from metals such as gold alloy, titanium or stainless steel, or from plastic resins or ceramics. Metallic spring members can be fabricated from stainless steel or titanium alloys. Elastomers can be selected from a variety of thermoplastic elastomers (TPE's), rubber, or silicone.

Variations in details of palate anchor connector 4 are possible. For example an alternate embodiment of actuator stud 15 is shown in FIG. 16. Actuator stud 200 still has familiar features such as central slot 26 and bevel 23, however double nibs 202 and single nib 201 emanate from distal end 203 adjacent to slot 26.

FIG. 17 shows that these form a mechanical captivating technique to keep actuator stud 200 attached to shell 11. By bending over dual nibs 202 and single nib 201 90 degrees toward slot 26, after insertion through the top surface of shell 11, they engage bar 25 to prevent withdrawal from shell 11. This embodiment is most compatible with a casting fabrication technique using ductile material such as gold alloy. Other mechanical techniques for retaining an actuator stud in lieu of constraint 24 formed by welding, solder, or adhesive involve the use of snap lock features or of tight fit dovetail elements near the distal end of slot 26.

Alternatively, nibs (not shown) could be pre-bent at an angle each forming a wedge having an undercut surface which enables them to be initially inserted downward and slid in place, but which undercut surfaces of the nibs resist upward movement when moved in an opposite direction against bar 25 to prevent withdrawal of shell 11.

Palate anchor connector 4 relies upon the nested engagement of a shell over a similarly contoured abutment (which resist relative rotation) and the use of one or more locking studs which penetrate both shell and abutment when engaged. Embodiments with two and three locking studs using a hexagonal contour have been described in this invention. Both elastomeric means as well as metallic cylindrical spring elements have been described as means to withdraw the locking studs when an actuator stud is withdrawn upward from the shell. These salient features permit the use of palate connectors 4 of a variety of contours with one or more locking studs operated in a similar fashion to the two or three stud embodiments detailed in this invention.

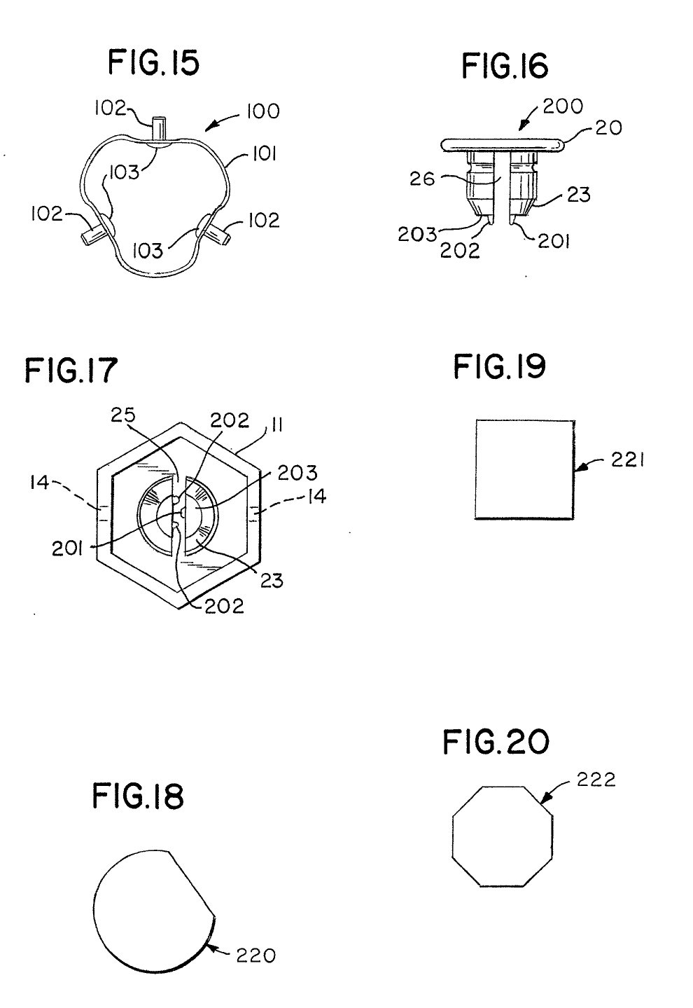

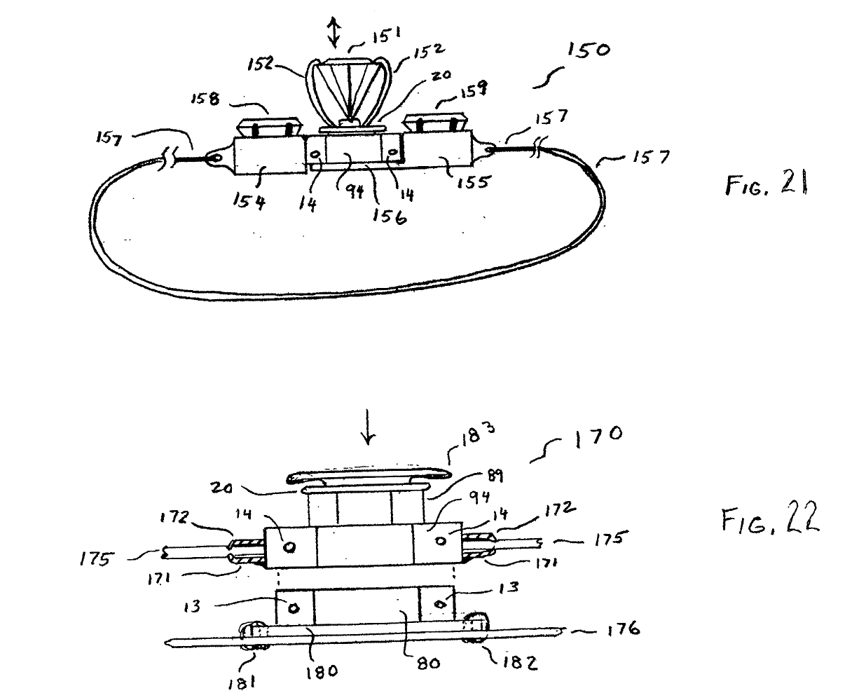

For example, an actuator stud can engage any number of locking studs by design. Top views of usable alternate contours for shells and abutments are shown in FIGS. 18-20. Since a circular contour would not resist relative rotation between shell and abutment, the circular contour with a flat or facet 220 as shown in FIG. 18 can be used. Similarly, a square 221 (FIG. 19) or an octagon 222 of FIG. 20 can be used. Less useful is a triangular shape because of the less favorable ratio of perimeter to enclosed area; this area must accommodate the moving mechanical elements.

FIG. 21 illustrates an application of the palate anchor connector described in FIGS. 12 through 15 to creating a hidden connector for items such as jewelry which is easy to use and provides great attachment security. Necklace 150 shows the ease with which the mechanism can be incorporated. Precious metal matching the material of the piece is used. Many variations are possible. Precious stone 151 is retained in a setting 152 attached to cap 20 of the actuator stud. The action to connect or disconnect the necklace is facilitated by pulling up lightly (to disconnect) or pressing down lightly to a “click” (to lock together) on stone 151. This mechanism is incorporated by attaching left side base 154 to shell 94. Right side base 155 with extension 156 is attached to abutment 80 (not shown in this view.within shell 94). Side stones 158 and 159 create the illusion of a continuous central section. Decorative chain 157 of any design is unbroken with a clasp. Necklace 150 is easily attached or detached by the user from the front with no fumbling or help required. It can be appreciated that similar techniques can be used to incorporate such a connection in a bracelet as well.

An enlarged version of the palate anchor connector of FIGS. 12 through 15 can also be used for clothing, creating a fast rugged method of providing closures for jackets and coats as shown in FIG. 22.

This system can also be used as a substitute for snaps such as for men's trousers; these will not “pop off” unexpectedly. Shell 94 and abutment 80 manufactured of molded plastic. Actuator stud 89 with cap 20 and attached grasp button 183 can also be molded. Shown in crossection, bottom grasp ring 171 is rigidly attached to shell 94 while ring 172 is press fit over shell 94 to crimp onto fabric layer 175 which a plain hole.

Alternatively, shell 94 can be attached to cloth layer 175 by sewing. Abutment 80 attached to platform 180 with holes in its periphery to sew onto an unbroken fabric layer 176.

FIG. 22 shows connector 170 in a disconnected state prior to reattachment by pressing down on button 183 after shell 94 seats onto abutment 80. Alternatively, a crimping system can be used for attachment.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention; as noted in the appended claims.

It is further known that other modifications may be made to the present invention, without departing the scope of the invention, as noted in the appended claims.

We claim:

1. A user removable orthodontic implant bracket for straightening teeth, wherein the implant is implanted into the palate roof of the mouth by a palate anchor attached to an implant, said orthodontic implant bracket having palatal connectors rigidly attached to said anchor, said connectors terminating at their respective distal ends in a tab which is adhesively attached to the surface of a tooth being straightened, said user removable orthodontic implant bracket comprising:
a detachable palate implant bracket connector being in a nested engagement with a stationary palate implant bracket connector; a first movable actuator engaging a first lock alternatively locking and unlocking said first detachable palate implant bracket connector to and from said nested engagement with said stationary palate implant bracket connector;
a detachable tooth connector being in a nested engagement with a stationary tab attached to a tooth; and,
a second movable actuator engaging a second lock alternatively locking and unlocking said detachable movable tooth connector to and from said nested engagement with said stationary tooth tab.

2. The user removable orthodontic implant bracket as claim 1 wherein said detachable palate implant bracket connector includes a hollow shell having a first geometric configuration,
said hollow palate implant bracket connector shell being detachable from said stationary palate implant bracket connector,
said stationary palate implant bracket connector being a stationary palate abutment having a similar geometric configuration to that of said detachable palate implant bracket shell,
said detachable palate implant bracket shell being in nested engagement in positional register with said stationary palate abutment, said detachable palate implant bracket shell and said stationary palate abutment being alternatively locked and unlocked by said first movable actuator engaging said at least one first lock,
said at least one first movable actuator engaging at least one lock comprising at least one activator stud movable from a first locking position to a second unlocking position,
said at least one first lock having a member penetrating both said detachable implant bracket connector shell and said stationary palate abutment,
said detachable implant bracket connector shell further connected by a spanning palate connector to said detachable tooth connector attached to said stationary tooth tab connected to said tooth,
wherein further said detachable tooth connector is a hollow socket having a second geometric configuration,
said detachable hollow tooth connector socket being detachable over a stationary tooth tab abutment having a similar second geometric configuration to that of said detachable hollow tooth bracket socket,
said detachable tooth connector socket being in nested engagement with said stationary tooth tab abutment, said detachable hollow tooth connector socket and said stationary tooth tab abutment being alternately locked and unlocked by said second movable actuator engaging at least one second lock, said at least one second lock comprising an activator stud movable from a first locking position to a second unlocking position penetrating both said detachable hollow tooth connector socket and said stationary tooth tab abutment.

3. The user removable orthodontic implant bracket as in claim 1 wherein each said geometric configuration of said first and said second geometric configurations is one of a group selected from a group consisting of a polygon, a square and a segmented circle, or a combination thereof.

4. The user removable orthodontic implant bracket as in claim 2 wherein said first movable actuator engaging said hollow detachable implant bracket connector shell further comprises a first manually activated cap and wherein said hollow detachable tooth bracket further comprises a second manually activated cap.

5. The user removable orthodontic implant bracket as in claim 4 wherein each said manually activated cap member is an upwardly extending cap.

6. The user removable orthodontic implant bracket as in claim 2 wherein said first movable actuator engages said at least one first lock having at least one locking stud alternately penetrating and releasing said hollow implant bracket connector shell from said nested engagement with said stationary palate abutment.

7. The user removable orthodontic implant bracket as in claim 2 wherein said second lock is at least one locking stud alternately penetrating and releasing said hollow detachable tooth bracket socket from said stationary tooth tab abutment.

8. The user removable orthodontic implant bracket as in claim 6 wherein said first movable actuator engaging said hollow implant bracket connector shell is pressed down to employ and retract said at least one locking stud of said at least one first lock.

9. The user removable orthodontic implant bracket as in claim 6 wherein said hollow tooth bracket socket is pressed down to employ and retract said at least one locking stud.

10. The user removable orthodontic implant bracket as in claim 2 wherein said stationary tooth tab abutment is a cubic protrusion attached to said stationary tooth tab bonded to a tooth, and said hollow tooth bracket socket is a conformable socket member with a cubic end cavity, said cubic end cavity being attached to an end of said spanning palate connector.

11. The user removable orthodontic implant as in claim 2 further comprising a first stop restraint preventing complete separation of said detachable palate implant bracket connector shell from said stationary palate abutment.

12. The user removable orthodontic implant as in claim 2 further comprising a second stop restraint preventing complete separation of said detachable hollow tooth connector socket from said stationary tooth tab abutment.

13. The user removable orthodontic implant as in claim 11 further comprising a flexible insert urging said hollow detachable palate implant bracket connector shell in a tight engagement with said stationary palate abutment.

14. The user removable orthodontic implant as in claim 12 further comprising a flexible insert urging said hollow detachable palate tooth bracket connector shell in a tight engagement with said stationary tooth tab abutment.

15. The user removable orthodontic implant as in claim 11 wherein said first stop restraint is at least one protrusion interrupting further movement of said hollow detachable palate implant bracket connector shell.

16. The user removable orthodontic implant as in claim 12 wherein said second stop restraint is at least one protrusion interrupting further movement of said hollow detachable tooth bracket socket tooth.

17. The user removable orthodontic implant as in claim 15 wherein said stop restraint is a bar extending access one side of said hollow detachable palate implant bracket connector shell.

18. The user removable orthodontic implant as in claim 16 wherein said stop restraint is a bar extending across one side of said hollow detachable tooth bracket socket.

19 The user removable orthodontic implant bracket as in claim 13 wherein said flexible insert is an annular elastomeric member.

20. The user removable orthodontic implant bracket as in claim 13 wherein said flexible insert is an annular metallic spring tubing.

21. The user removable orthodontic implant bracket as in claim 14 wherein said flexible insert is an annular elastomeric member.

22. The user removable orthodontic implant bracket as in claim 14 wherein said flexible insert is an annular metallic spring tubing.

23. The user removable orthodontic implant bracket as in claim 2 wherein said at least first lock locking said hollow detachable implant bracket connector shell and said stationary palate abutment is a pair of diametrically opposed locking studs.

24. The user removable orthodontic implant bracket as in claim 2 wherein said at least one second lock locking said hollow detachable tooth tab socket to said stationary tooth tab abutment is a pair of diametrically opposed locking studs.

25. The user removable orthodontic implant bracket as in claim 2 wherein said at least one first lock locking said hollow detachable implant bracket connector shell and said stationary palate abutment is three equally spaced apart locking studs.

26. The user removable orthodontic implant bracket as in claim 2 wherein said at least one second lock locking said hollow detachable tooth connector socket to said stationary tooth tab abutment is three equally apart locking studs.

27. The user removable orthodontic implant bracket as in claim 2 further comprising at least one audible signal producing member signaling correct engagement of said hollow detachable implant bracket connector shell with said stationary palate abutment.

28. The user removable orthodontic implant bracket as in claim 2 further comprising at least one audible signal producing member signaling correct engagement of said hollow detachable tooth connector socket with said stationary tooth tab abutment.

29. The user removal orthodontic implant bracket as in claim 27 wherein said audible signal producing member is a recess within said stationary palate abutment making an audible click upon engagement with an edge of a surface of said hollow detachable implant bracket connector shell.

30. The user removal orthodontic implant bracket as in claim 27 wherein said audible signal producing member is a recess within said stationary tooth tab abutment making an audible click upon engagement with an edge of a surface of said hollow detachable tooth connector socket.

31. A user removable fastener for a jewelry piece having a first end connected to a second end, said fastener comprising a detachable connector in nested engagement with a stationary connector, a lock alternately locking and unlocking said detachable connector from said nested engagement with said stationary connector, said detachable connector slidably detachable from a first lowered locking position to a second raised unlocked position, said unlocked fastener disconnecting said first end from said second end, wherein said one end of said jewelry piece is connected to said detachable connector and another end of said jewelry piece is connected to said stationary connector.

32. A user removable fastener for an article of clothing having a first fabric layer connectable to a second fabric layer providing closures for said article of clothing, comprising a detachable connector, in nested engagement with a stationary connector, a lock alternately locking and unlocking said detachable connector from said nested engagement with said stationary connector, said detachable connector slidably detachable from a first lowered locking position to a second raised unlocked position, said unlocked fastener disconnecting said first fabric layer from said serial fabric layer.
